(19) United States
(12) Patent Application Publication
(10) Pub. No.: US 2010/0054320 A1
(43) Pub. Date: Mar. 4, 2010

(54) AMPLITUDE EQUALIZER FOR FM TRANSMITTERS

(75) Inventor: John Glissmann, Manila (PH)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., MOUNTAIN VIEW, CA (US)

(21) Appl. No.: 12/374,441

(22) PCT Filed: Jul. 20, 2007
(86) PCT No.: PCT/US07/74027

§ 371 Date: Sep. 17, 2009

Related U.S. Application Data
(60) Provisional application No. 60/807,930, filed on Jul. 20, 2006.

(51) Int. Cl. H04L 27/01; H04L 25/03

(52) U.S. Cl. 375/230; 375/296

(57) ABSTRACT

An improved amplitude equalizer for FM transmitters that compensates for undesirable frequency response characteristics in an audio source or in an FM receiver. In a preferred embodiment, the amplitude equalizer includes a pre-emphasis network including a set of components that can be selectively switched in and out of the network so that a transmitter operator may select the type of pre-emphasis most appropriate to the audio source for the transmitter and the system that demodulates and reproduces the audio signals transmitted.

### BACKGROUND OF THE INVENTION

1. Technical Field

The present invention relates generally to FM transmitters, and more particularly to a low cost amplitude equalizer for FM transmitters having a design methodology and low cost circuit implementation that allows the user to compensate for undesirable frequency response characteristics in an audio source or in an FM receiver.

2. Background Art

In the transmission of audio signals from digital audio devices (such as MP3 players, CD players, satellite receivers, and so forth) via the commercial FM stereo broadcast standard, several potential sources of signal degradation exist. One such degradation can be in audio frequency response, and this can occur anywhere in the link, including at the audio source, at the FM transmitter, the FM receiver, or in speakers or headphones. The most common frequency response anomalies are roll off of audio response at low and/or high frequencies.

The FM broadcast standard used in the United States incorporates a 75 μS pre-emphasis network in the transmitter and a 75 μS de-emphasis network in the receiver to improve the signal-to-noise ratio in the higher baseband frequencies. A 50 μS network is the standard in most of the rest of the world. FIG. 1A shows a possible transmitter pre-emphasis circuit implementation. This is used in the currently existing Rohm BH14xx family of FM transmitter integrated circuits. FIG. 1B shows a typical prior art complementary de-emphasis network as would be used with the receiver for the transmitter of FIG. 1A. The emphasis network in the transmitter causes a roll-up in frequency response with the break point at 2.1 KHz, and following a 6 dB per octave slope. The corresponding receiver de-emphasis network is matched to the transmitter network and causes a roll-off of frequency response that is the complement of the transmitter network, resulting in a flat composite response, and a significant improvement in the triangular spectral noise distribution inherent in FM systems.

The foregoing discussion regarding prior art pre-emphasis and de-emphasis circuits reflects the current state of the art of which the present inventor is aware. The inclusion of this discussion is intended to aid in discharging Applicant's acknowledged duty of candor in disclosing information that may be relevant to the examination of claims to the present invention. However, it is respectfully submitted that the above-described circuits do not disclose, teach, suggest, show, or otherwise render obvious, either singly or when considered in combination, the invention described and claimed herein.

### DISCLOSURE OF INVENTION

The amplitude equalizer for FM transmitters of the present invention takes advantage of the pre-emphasis circuit topology typically used in FM transmitters to implement a very low cost amplitude equalizer for correcting objectionable frequency response characteristics in an audio system.

It is an object of this invention to provide a high frequency roll up or roll off in frequency response by controlling the time-constant of the pre-emphasis network. This is accomplished by switching the capacitor value in an RC network.

It is a further object of this invention to provide a “bass boost” function by reducing the pre-emphasis characteristic. This is accomplished by switching a resistor in parallel with the capacitor in an RC network.

It is another object of this invention to provide both a high frequency roll up or roll off in frequency response and to also provide a “bass boost” function by reducing the pre-emphasis characteristic. This is accomplished by switching both a capacitor and a resistor in parallel with the capacitor in an RC network.

It is yet another object of this invention to show the implementation of this audio equalizer function with a 1 pole multi-throw switch.

An even further object of this invention is to show the implementation of this audio equalizer using a programmable logic device.

A still further object of this invention is to show the implementation of this audio equalizer function using a microprocessor or DSP processor.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawings are for the purposes of illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1A is a schematic circuit diagram of a typical prior art transmitter emphasis network;

FIG. 1B is a schematic circuit diagram of a typical prior art receiver de-emphasis network complementary to the transmitter emphasis network shown in FIG. 1A;

FIG. 1C is a graph illustrating the visual output of a spectrum analyzer showing the effect of using the transmitter pre-emphasis of FIG. 1A in combination with the receiver de-emphasis of FIG. 1B;

FIG. 2A is a schematic circuit diagram showing the pre-emphasis circuit FIG. 1A, with a change in the value of a capacitor;

FIG. 2B is a graph showing the composite audio frequency response obtained by using the transmitter pre-emphasis circuit of FIG. 2A in combination with the receiver de-emphasis network shown in FIG. 1B;

FIG. 3A is a schematic circuit diagram showing another pre-emphasis circuit FIG. 1A, with yet another change in the value of a capacitor;

FIG. 3B is a graph showing the composite audio frequency response obtained by using the transmitter pre-emphasis circuit of FIG. 3A in combination with the receiver de-emphasis network shown in FIG. 1B;

FIG. 4A is a schematic circuit diagram showing another pre-emphasis circuit FIG. 1A, with yet another change in the value of a capacitor;

FIG. 4B is a graph showing the composite audio frequency response obtained by using the transmitter pre-emphasis circuit of FIG. 4A in combination with the receiver de-emphasis network shown in FIG. 1B;

FIG. 5A is a schematic circuit diagram showing another pre-emphasis circuit FIG. 1A, with a change in the value of a resistor;

FIG. 5B is a graph showing the composite audio frequency response obtained by using the transmitter pre-emphasis circuit of FIG. 5A in combination with the receiver de-emphasis network shown in FIG. 1B;

FIG. 6A, is a schematic circuit diagram showing the circuit represented in FIG. 1A, with a change in the value of a capacitor, and further showing a multi-position equalizer function utilizing the above emphasis network values controlled by a slide switch; and

FIG. 6B is a graph showing the composite audio frequency response obtained by using the transmitter pre-emphasis configuration shown in FIG. 6A in combination with a the receiver de-emphasis network of FIG. 1B, using an exemplary switch setting.

### BEST MODE FOR CARRYING OUT THE INVENTION

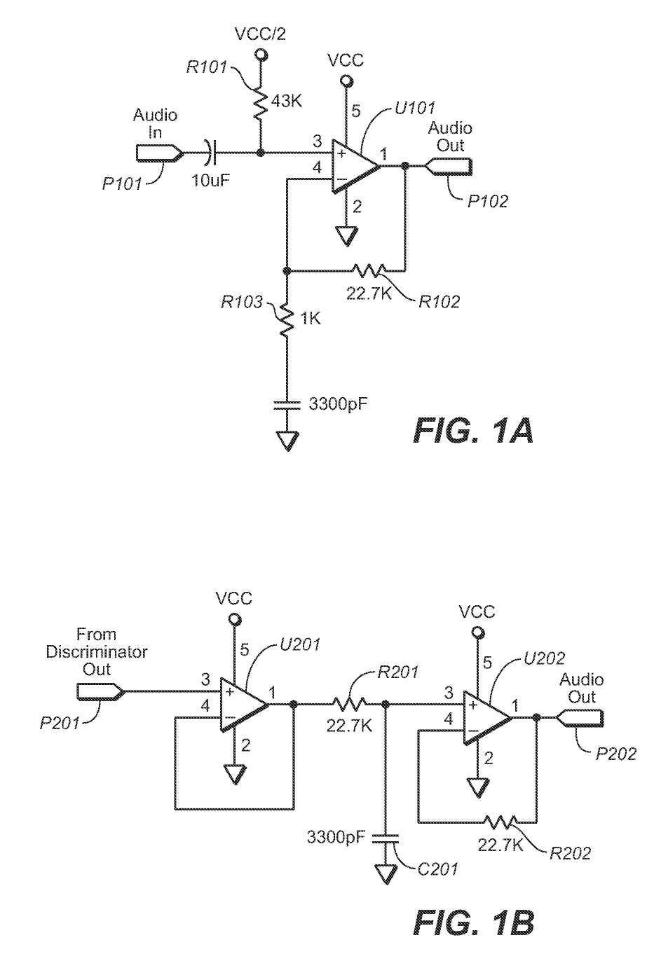

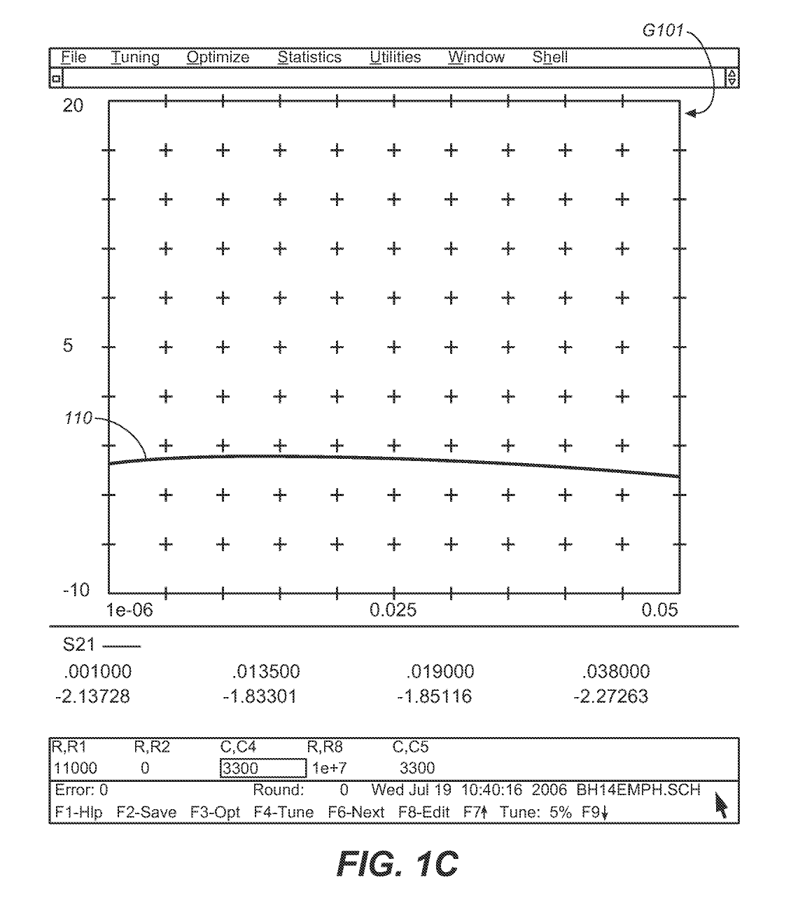

Referring to FIGS. 1A through 6B, wherein like numbers refer to like elements in the various views, and referring first to FIG. 1A, there is shown a schematic diagram of a typical transmitter pre-emphasis network circuit. A well-known operational amplifier op-amp U101 is configured to act as a frequency response shaping stage in an audio circuit. Arriving at connection point P101 is unfiltered audio from an electronic audio source, such as a well-known compact disc music player, or MP3 player. The unfiltered audio signal is passed to the positive input of op-amp U101 via DC-blocking capacitor C101 and pin 3 of op-amp U101. The processed signal from op-amp U101 is fed toward a transmitter's modulation circuit via pin 1 of op-amp U101 and connection point P102. Vcc power is provided to op-amp U101 directly via pin 5 of op-amp U101. Op-amp U101 is connected directly to circuit ground through pin 2 of op-amp U101.

Resistor R101 is connected between bias current source VCC/2 and positive input pin 3 of op-amp U101, providing a DC bias current to op-amp U101. The DC bias current value sets the quiescent DC voltage value at output pin 1 of op-amp U101 (the DC voltage at which pin 1 will be when no input signal is present). The value of resistor R101 determines the amount of DC bias current available at positive input pin 3 of op-amp U101.

Resistor R102 is connected between output pin 1 of op-amp U101 and negative input pin 4 of op-amp U101, thereby providing a direct real time negative feedback DC voltage to control the overall output amplitude gain of op-amp U101. In this way, the value of resistor R102 determines the gain of op-amp U101.

The value of resistor R102 is set in relation to the value of resistor R101. Resistors R101 and R102 are set to values that provide the appropriate gain for op-amp U101, and set the quiescent DC value at output pin 1 of op-amp U101 so that the negative half of the output waveform signal will never go below zero volts DC (keeping the entire output waveform above zero volts DC).

Still referring to FIG. 1A, pin 4 of op-amp U101 is connected to circuit ground serially through resistor R103 and capacitor C102. The values of resistor R103 and capacitor C102 determine the frequency response of the overall stage circuit. In this form, the circuit provides 75-microsecond emphasis due to the values of resistor R103 (1000 Ohms) and capacitor C102 (3300 Pico-Farads).

Still referring to FIG. 1A, graph G101 represent the visual output of a spectrum analyzer that shows the composite effect of using the transmitter pre-emphasis configuration (shown in FIG. 1A) in combination with a typical receiver de-emphasis network (shown in FIG. 1B). In graph G101, the vertical scale represents relative amplitude marked in 3 dB increments, and the horizontal scale represents an audio frequency range between 0 Hz and 50 KHz marked in 10 KHz increments.

The composite frequency response of using the transmitter pre-emphasis configuration (shown in FIG. 1A) in combination with a typical receiver de-emphasis network (shown in FIG. 1B) is tested using the following steps:

First, integrated into a typical FM receiver (as a post-demodulator audio processing stage), the receiver de-emphasis circuit shown in FIG. 1B.

Second, tune the receive frequency of the RF receiver to a frequency that is not used locally.

Third, connect a spectrum analyzer the audio output (at connection point P202) of the receiver de-emphasis circuit shown in FIG. 1B.

Fourth, integrate into a typical FM transmitter (as a pre-modulator audio processing stage) the transmitter pre-emphasis circuit shown in FIG. 1A.

Fifth, tune the transmit frequency of the FM transmitter to the same frequency to which the FM receiver is tuned.

Sixth, connect an audio signal generator with frequency sweeping capability to connection point P101 of the transmitter pre-emphasis circuit shown in FIG. 1A.

Seventh, ensure that there is a clear RF signal path between the FM transmitter and FM receiver, so that modulated signals transmitted by the FM transmitter are received by the FM receiver without significant interference or fading (make certain the FM receiver is receiving a good signal from the FM transmitter).

Eighth, key the FM transmitter and use the audio signal generator to impress an audio signal of the appropriate amplitude onto connection point P101 of the transmitter pre-emphasis circuit shown in FIG. 1A. Sweep the audio signal through the frequency range of 0 Hz through 50 KHz.

Now referring to FIG. 1C, the resulting measurements made by the spectrum analyzer during this test are shown as graph line 110 on graph G101, which represents the relative amplitude of the signal at each point on the frequency spectrum between 0 Hz and 50 KHz as it exits the de-emphasis network depicted in FIG. 1B. As can be seen by perusing graph G101, the composite frequency response of using the transmitter pre-emphasis configuration (shown in FIG. 1A) in combination with a typical receiver de-emphasis network (shown in FIG. 1B) is relatively flat, with no significant roll-up or roll-down of the low or high audio frequencies.

Referring now to FIG. 1B, a schematic diagram of a typical receiver de-emphasis network circuit is shown. This circuit is configured to complement the circuit of FIG. 1A. A pair of well-known operational amplifiers op-amp U201 and op-amp U202 are configured to act as a frequency response shaping stage in an audio circuit. Arriving at connection point P201 is pre-emphasized audio from an electronic audio source, such as a well-known receiver demodulator circuit. The pre-emphasized audio signal is passed directly to the positive input of op-amp U201 via pin 3 of op-amp U201. Vcc power is provided to op-amp U201 directly via pin 5 of op-amp U201. Op-amp U201 is connected directly to circuit ground through pin 2 of op-amp U201. The overall amplification gain of op-amp U201 is set to unity (no gain) by having pin 4 of op-amp U201 connected directly to pin 1 of op-amp 201.

Still referring to FIG. 1B, it can be seen that op-amp U201 drives the pre-emphasized audio signal through the RC filter network comprised of resistor R201 and capacitor C201 and into the positive input of op-amp U202 via pin 3 of op-amp U202. Op-amp U202 acts as a buffer amplifier, passing the processed audio signal from op-amp U202 to an audio amplification circuit via pin 1 of op-amp U202 and connection point P202. Vcc power is provided to op-amp U202 directly via pin 5 of op-amp U202. Op-amp U202 is connected directly to circuit ground through pin 2 of op-amp U202. The overall amplification gain of op-amp U202 is by the value resistor R202 (connected directly between pin 4 of op-amp U201 and pin 1 of op-amp 201).

The values of resistor R201 and capacitor C201 determine the frequency response of the overall stage circuit. In this form, the circuit provides 75-microsecond de-emphasis due to the values of resistor R201 (22700 Ohms) and capacitor C201 (3300 Pico-Farads). Thus, the audio de-emphasis circuit shown in FIG. 1B represents the typical implementation found in most commercially available receivers.

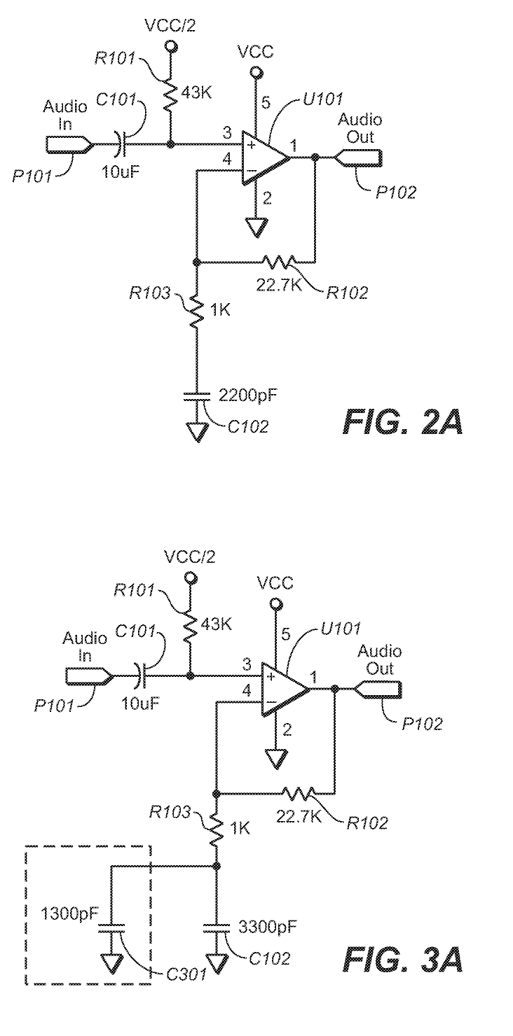

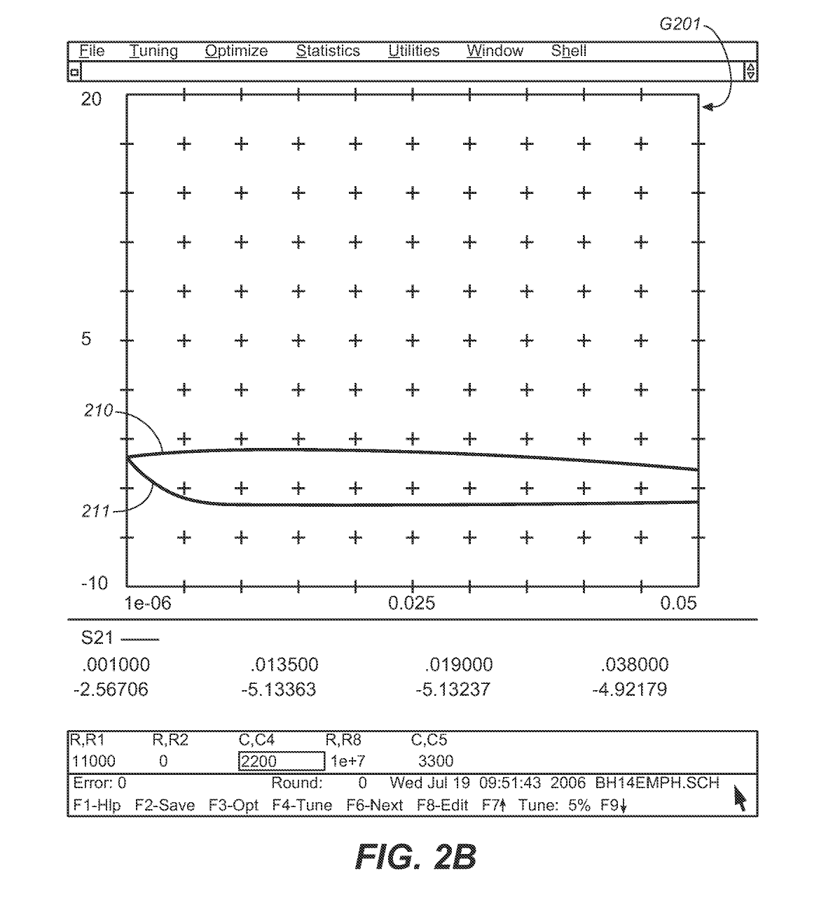

Now referring to the pre-emphasis circuit of FIG. 2A, it can be seen that this is the same circuit represented in FIG. 1A, with the exception that the value of capacitor C102 has been changed to 2200 Pico-Farads, thus resulting in a 50-microsecond pre-emphasis. The composite audio frequency response obtained by using the transmitter pre-emphasis configuration shown in FIG. 2A in combination with a typical receiver de-emphasis network (shown in FIG. 1B) is different than that obtained when the transmitter pre-emphasis configuration shown in FIG. 1A is used. This can be seen in graph G201 of FIG. 2B.

Graph G201 is configured and derived in the same manner as is graph G101. Graph line 210 on graph FIG. 2B represents the relative amplitude of the signal at each point on the frequency spectrum between 0 Hz and 50 KHz as it exits the de-emphasis network depicted in FIG. 1B when using the transmitter pre-emphasis configuration shown in FIG. 1A. Graph line 210 is used as a comparison baseline when observing graph line 211. Graph line 211 on graph FIG. 2B represents the relative amplitude of the signal at each point on the frequency spectrum between 0 Hz and 50 KHz as it exits the de-emphasis network depicted in FIG. 1B when using the transmitter pre-emphasis configuration shown in FIG. 2A.

As can be seen by perusing the graph of FIG. 2B, when using the transmitter pre-emphasis configuration (shown in FIG. 2A) in combination with a typical receiver de-emphasis network (shown in FIG. 1B) the composite frequency response has an approximately 3 dB reduction in gain (roll-down) of the audio frequencies greater than 5 KHz.

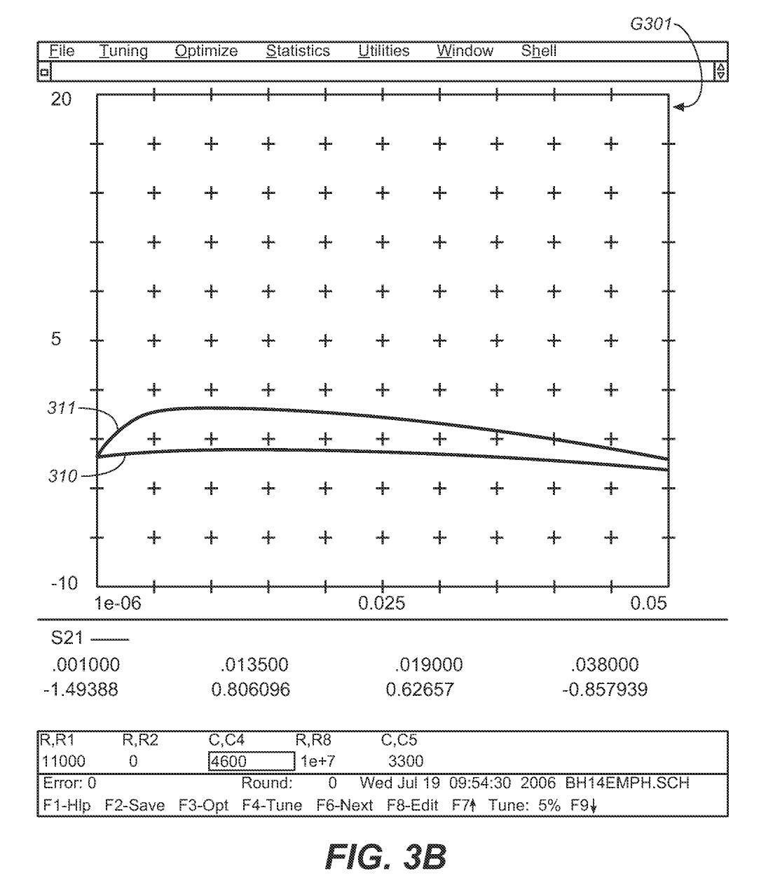

Referring now to the pre-emphasis circuit of FIG. 3A, it can be seen that this is the same circuit represented in FIG. 1A, with the exception that capacitor C301 (with a value of 1300 Pico-Farads) is placed in parallel with capacitor C102, thus resulting in a 104-microsecond pre-emphasis. Referring next to FIG. 3B, it will be seen that the composite audio frequency response obtained by using the transmitter pre-emphasis configuration shown in FIG. 3A in combination with a typical receiver de-emphasis network (shown in FIG. 1B) is different than that obtained when the transmitter pre-emphasis configuration shown in FIG. 1A is used. This can be seen in graph G301.

Graph G301 is configured and derived in the same manner as is graph G101. Graph line 310 on graph G301 represents the relative amplitude of the signal at each point on the frequency spectrum between 0 Hz and 50 KHz as it exits the de-emphasis network depicted in FIG. 1B when using the transmitter pre-emphasis configuration shown in FIG. 1A. Graph line 310 is used as a comparison baseline when observing graph line 311. Graph line 311 on graph G301 represents the relative amplitude of the signal at each point on the frequency spectrum between 0 Hz and 50 KHz as it exits the de-emphasis network depicted in FIG. 1B when using the transmitter pre-emphasis configuration shown in FIG. 3A.

As can be seen from graph 301, when using the transmitter pre-emphasis configuration (shown in FIG. 3A) in combination with a typical receiver de-emphasis network (shown in FIG. 1B) the composite frequency response has an approximately 3 dB increase in gain (roll-up) of the audio frequencies greater than 5 KHz.

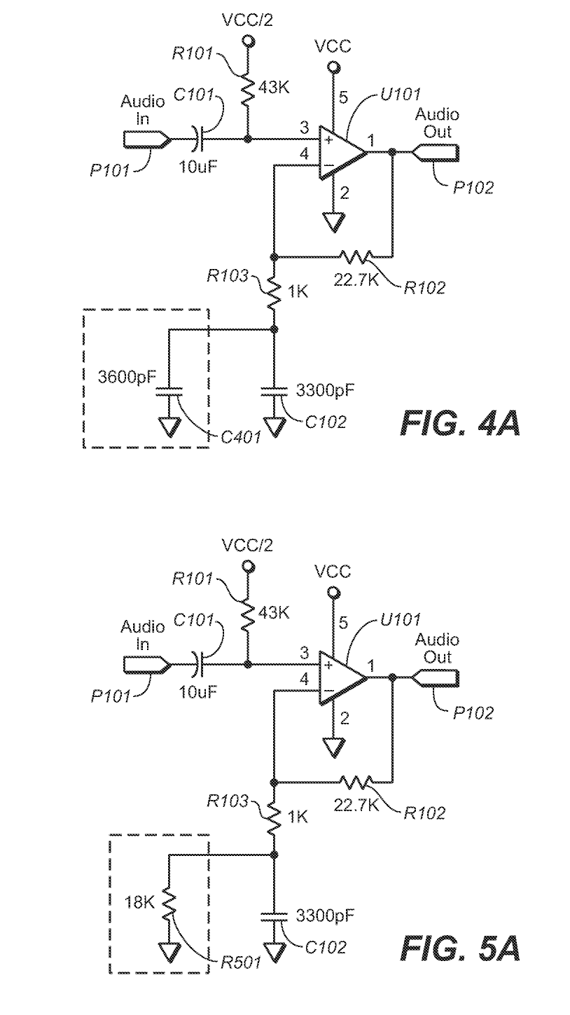

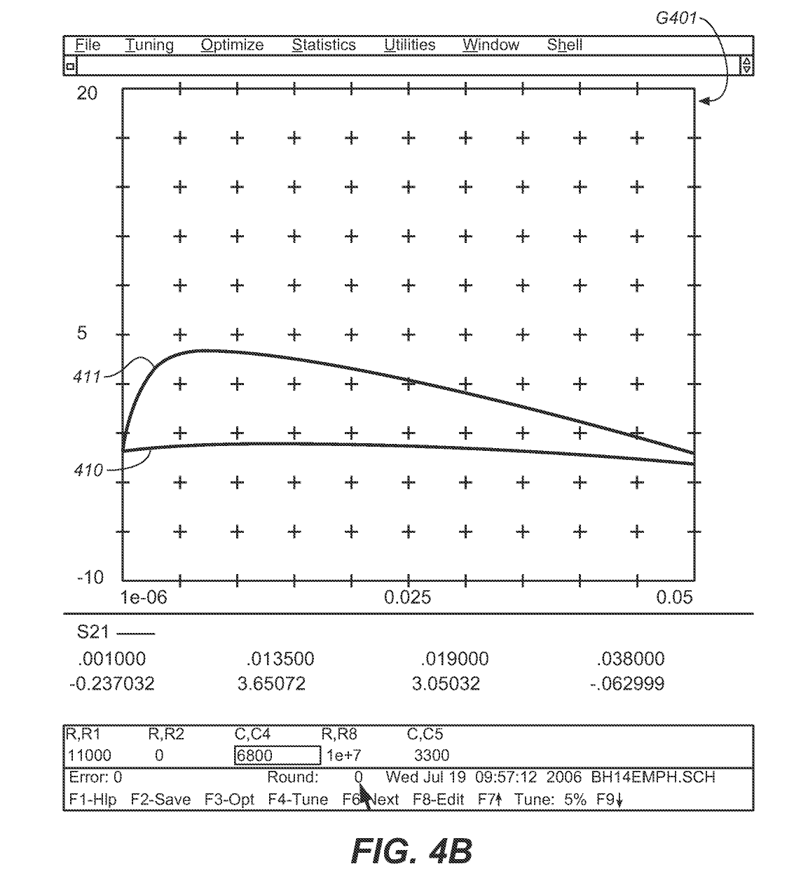

Referring now to the pre-emphasis circuit of FIG. 4A, it can be seen that this is the same circuit represented in FIG. 1A, with the exception that capacitor C401 (with a value of 3300 Pico-Farads) is placed in parallel with capacitor C102, thus resulting in a 157-microsecond pre-emphasis. The composite audio frequency response obtained by using the transmitter pre-emphasis configuration shown in FIG. 4A in combination with a typical receiver de-emphasis network (shown in FIG. 1B) is different than that obtained when the transmitter pre-emphasis configuration shown in FIG. 1A is used. This can be seen in graph G401.

Graph G401 is configured and derived in the same manner as is graph G101. Graph line 410 on graph G401 represents the relative amplitude of the signal at each point on the frequency spectrum between 0 Hz and 50 KHz as it exits the de-emphasis network depicted in FIG. 1B when using the transmitter pre-emphasis configuration shown in FIG. 1A. Graph line 410 is used as a comparison baseline when observing graph line 411. Graph line 411 on graph G401 represents the relative amplitude of the signal at each point on the frequency spectrum between 0 Hz and 50 KHz as it exits the de-emphasis network depicted in FIG. 1B when using the transmitter pre-emphasis configuration shown in FIG. 4A.

As can be seen by observing graph 401, when using the transmitter pre-emphasis configuration (shown in FIG. 4A) in combination with a typical receiver de-emphasis network (shown in FIG. 1B) the composite frequency response has an approximately 6 dB increase in gain (roll-up) of the audio frequencies greater than 5 KHz.

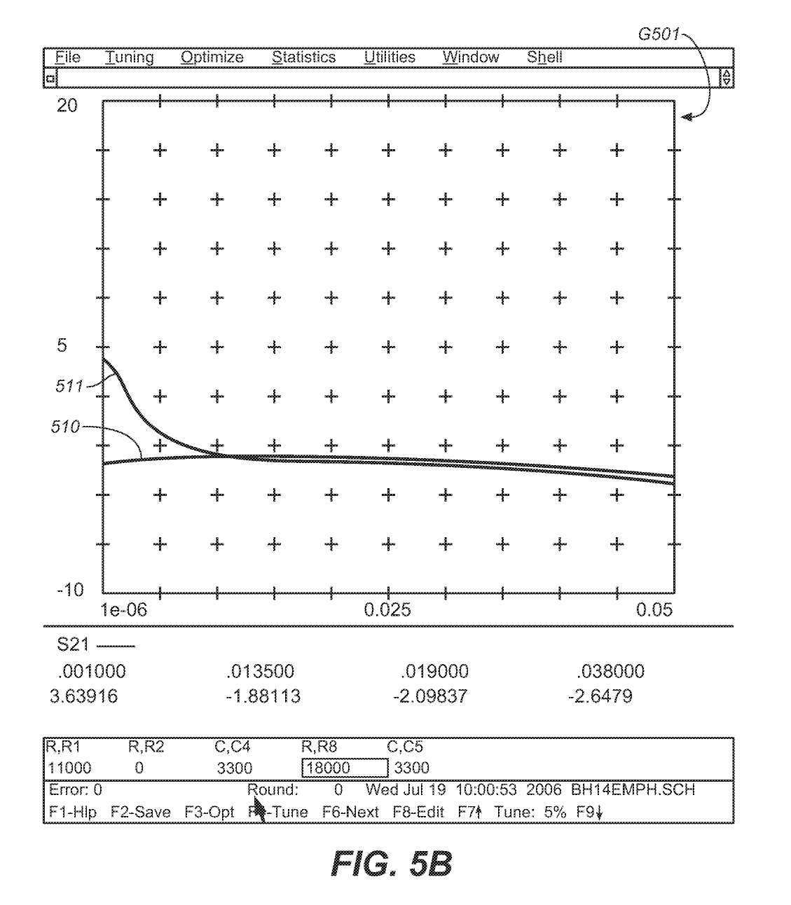

Referring now to the pre-emphasis circuit of FIG. 5A, it can be seen that this is the same circuit represented in FIG. 1A, with the exception that resistor R501 (with a value of 18000 Ohms) is placed in parallel with capacitor C102, thus resulting in a reduced pre-emphasis. The composite audio frequency response obtained by using the transmitter pre-emphasis configuration shown in FIG. 5A in combination with a typical receiver de-emphasis network (shown in FIG. 1B) is different than that obtained when the transmitter pre-emphasis configuration shown in FIG. 1A is used. This can be seen in graph G501.

Graph G501 is configured and derived in the same manner as is graph G101. Graph line 510 on graph G501 represents the relative amplitude of the signal at each point on the frequency spectrum between 0 Hz and 50 KHz as it exits the de-emphasis network depicted in FIG. 1B when using the transmitter pre-emphasis configuration shown in FIG. 1A. Graph line 510 is used as a comparison baseline when observing graph line 511. Graph line 511 on graph G501 represents the relative amplitude of the signal at each point on the frequency spectrum between 0 Hz and 50 KHz as it exits the de-emphasis network depicted in FIG. 1B when using the transmitter pre-emphasis configuration shown in FIG. 5A.

As can be seen by observing graph 501, when using the transmitter pre-emphasis configuration (shown in FIG. 5A) in combination with a typical receiver de-emphasis network (shown in FIG. 1B) the composite frequency response has an approximately 6 db increase in gain (roll-up) of the audio frequencies below 5 KHz.

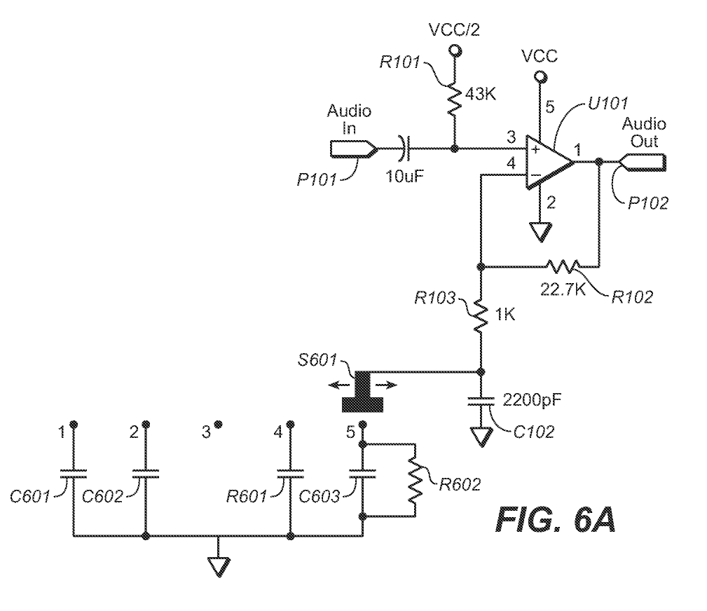

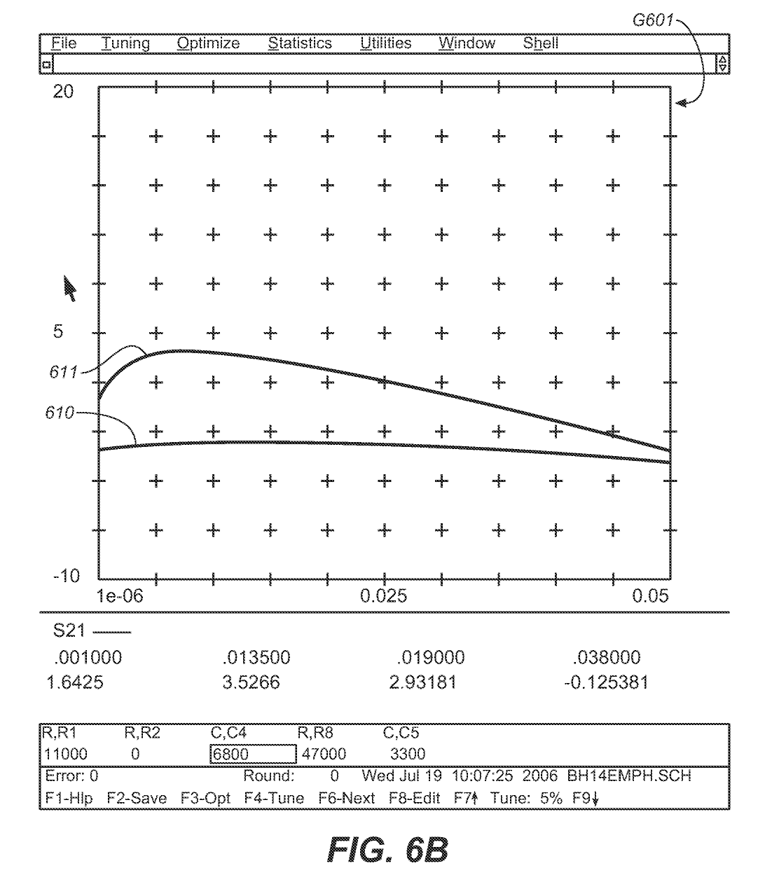

Referring now to the pre-emphasis circuit of FIG. 6A, it can be seen that this is the same circuit represented in FIG. 1A, with the exception that the value of capacitor C102 is changed to 2200 Pico-Farads, and connected between circuit ground and the junction of resistor R103 and capacitor C102 is a set of components that can be switched in and out of the circuit by the actions of switch S601.

Switch S601 is 5-position single-pole multi-throw switch that connects (depending on its throw position) the junction of resistor R103 and capacitor C102 with capacitor C601, capacitor C602, resistor R601 or the parallel combination of capacitor C603 and resistor R602. It should be noted that a person reasonably skilled in the art would easily see that S601 can be replaced by a well-known programmable logic device (PLD), microprocessor, digital signal processor (DSP) or any switching device capable of single-pole multi-throw operation.

In position 1, switch S601 connects the junction of resistor R103 and capacitor C102 with capacitor C601 (having a value of 2400 Pico-Farads), thus creating a pre-emphasis that provides approximately 4.5 dB of increased gain at frequencies above 5 KHz.

In position 2, switch S601 connects the junction of resistor R103 and capacitor C102 with capacitor C602 (having a value of 1000 Pico-Farads), thus creating a pre-emphasis of 75 microseconds (the same as is typical of state of the art pre-emphasis circuits typically used in commercial transmitters). This configuration provides relatively flat gain across frequencies between 0 KHz and 50 KHz.

In position 3, switch S601 is open (connecting no additional components with the junction of resistor R103 and capacitor C102), thus creating a pre-emphasis of 50 microseconds, which provides approximately 3 dB of decreased gain at frequencies above 5 KHz.

In position 4, switch S601 connects the junction of resistor R103 and capacitor C102 with resistor R601 (having a value of 18000 Ohms, thus creating a pre-emphasis that provides approximately 6 dB of increased gain at frequencies below 5 KHz.

In position 5, switch S601 connects the junction of resistor R103 and capacitor C102 with the parallel components of capacitor C603 (having a value of 2400 Pico-Farads) and resistor R602 (having a value of 47000 Ohms). This creates a pre-emphasis that provides approximately 3 dB of increased gain at frequencies below 5 KHz, as well as approximately 4.5 dB of increased gain at frequencies above 5 KHz.

The composite audio frequency response obtained by using the transmitter pre-emphasis configuration shown in FIG. 6A in combination with a typical receiver de-emphasis network (shown in FIG. 1B) is different than that obtained when the transmitter pre-emphasis configuration shown in FIG. 1A is used. An example of this can be seen in graph G601.

Graph G601 is configured and derived in the same manner as is graph G101. Graph line 610 on graph G601 represents the relative amplitude of the signal at each point on the frequency spectrum between 0 Hz and 50 KHz as it exits the de-emphasis network depicted in FIG. 1B when using the transmitter pre-emphasis configuration shown in FIG. 1A (and switch S601 is placed into position 5). Graph line 610 is used as a comparison baseline when observing graph line 611. Graph line 611 on graph G601 represents the relative amplitude of the signal at each point on the frequency spectrum between 0 Hz and 50 KHz as it exits the de-emphasis network depicted in FIG. 1B when using the transmitter pre-emphasis configuration shown in FIG. 6A (wherein switch S601 is placed into position 5).

As can be seen from graph 601, when using the transmitter pre-emphasis configuration (shown in FIG. 6A) in combination with a typical receiver de-emphasis network (shown in FIG. 1B), and wherein switch S601 is placed into position 5, the composite frequency response has an approximately 6 db increase in gain (roll-up) of the audio frequencies below 5 KHz as well as an approximately 6 db increase in gain (roll-up) of the audio frequencies above 5 KHz.

Thus it is seen that a pre-emphasis circuit that feeds an FM transmitter modulation circuit can be made to provide a frequency response shaping circuit that is more useful in practical application than the circuit configurations of pre-emphasis circuits currently used in the art. If a transmitter operator integrates the embodiment of the present invention shown in FIG. 6A into the signal path between an audio source and the modulator circuit of the transmitter, it is possible for the transmitter operator to select the type of pre-emphasis that is most appropriate to the transmitter's audio source and the system that finally demodulates and reproduces the audio signals being transmitted.

It can also be seen that a typical receiver audio de-emphasis circuit (as shown in FIG. 1B) can also be modified to change its de-emphasis characteristics by changing one or both of the component values in the RC audio frequency filter network comprised resistor R201 and capacitor C201. If a receiver operator modifies the values of either resistor R201 or capacitor C201, then the resulting change in the de-emphasis characteristics of the circuit will cause the frequency response of the receiver to change accordingly. This can be implemented with a switched arrangement so that various values can be switched in and out of the circuit, thus allowing the receiver operator to select the most appropriate de-emphasis characteristics based on the audio source and the receiving system's audio reproduction capabilities.

The foregoing disclosure is sufficient to enable those with skill in the relevant art to practice the invention without undue experimentation. The disclosure further provides the best mode of practicing the invention now contemplated by the inventor.

While the particular amplitude equalizer and method herein shown and disclosed in detail is fully capable of attaining the objects and providing the advantages stated herein, it is to be understood that it is merely illustrative of the presently preferred embodiment of the invention and that no limitations are intended concerning the detail of construction or design shown other than as defined in the appended claims. Accordingly, the proper scope of the present invention should be determined only by the broadest interpretation of the appended claims so as to encompass obvious modifications as well as all relationships equivalent to those illustrated in the drawings and described in the specification.

What is claimed as invention is:

1. An improved pre-emphasis network for an amplitude equalizer to correct objectionable frequency response characteristics in an audio system, the pre-emphasis network including an input connection point P101 for receiving an unfiltered audio signal from an electronic audio source, an operational amplifier U101 connected to the input connection point and configured to act as a frequency response shaping stage, the op-amp being provided with Vcc supply power directly through a power input pin and having a first resistor R101 connected between a bias current source VCC/2 and the positive input pin of op-amp U101, a positive input pin for receiving the unfiltered audio signal from the input connection point, a first capacitor C101 interposed between the input connection point and the positive audio input pin, a direct connection to circuit ground through a first ground pin, and an indirect connection to circuit ground through a serially disposed third resistor R103 and a second capacitor C102 through a second ground pin, wherein the values of the third resistor R103 and second capacitor C102 determine the frequency response of the overall stage circuit, wherein the op-amp processes the signal and feeds it through an audio output pin toward a transmitter modulation circuit and an output connection point P102 and through a second resistor R102 connected between the audio output pin and a negative input pin of the op-amp, thereby providing a direct real time negative feedback DC voltage to control the overall output amplitude gain of the op-amp, such that the ratio of the values of the first resistor R101 and the second resistor R102 sets the overall amplification gain of op-amp U101;
the improvement comprising at least one circuit device or variations in existing circuit device values to change the time constant of the pre-emphasis network, to reduce the pre-emphasis characteristic, to provide a bass boost function, or to accomplish any combination thereof.

2. The pre-emphasis network of claim 1, wherein the value of said second capacitor C102 is selected to result in a 50-microsecond pre-emphasis time constant.

3. The pre-emphasis network of claim 1, wherein the value of said second capacitor C102 is 2200 Pico-Farads.

4. The pre-emphasis network of claim 1, further including a third capacitor C301/C401 disposed in parallel with second capacitor C102, wherein the value of capacitor C301/C401 is selected to result in a 104-microsecond pre-emphasis.

5. The pre-emphasis network of claim 4, wherein the value of said third capacitor is 1300 Pico-Farads.

6. The pre-emphasis network of claim 4, wherein the value of said third capacitor is selected to result in a 157-microsecond pre-emphasis.

7. The pre-emphasis network of claim 6, wherein the value of said third capacitor is 3300 Pico-Farads.

8. The pre-emphasis network of claim 1, further including a third resistor R501 placed in parallel with said second capacitor C102, and having a value selected to result in a reduced pre-emphasis.

9. The pre-emphasis network of claim 7, wherein the value of said third resistor is 18000 Ohms.

10. The pre-emphasis network of claim 1, further including a set of components connected between circuit ground and the junction of said third resistor R103 and said second capacitor C102 that can be selectively switched in and out of said pre-emphasis network by the actions of a switch S601, whereby switch position selections result in changes in the pre-emphasis network performance characteristics.

11. The pre-emphasis network of claim 10, wherein the value of said second capacitor C102 is 2200 Pico-Farads.

12. The pre-emphasis network of claim 10, wherein said switch S601 is multi-position single-pole multi-throw switch that selectively connects the junction of said third resistor R103 and said second capacitor C102 with a third capacitor C601, a fourth capacitor C602, a fourth resistor R601, or a parallel combination of a fifth capacitor C603 and a fifth resistor R602.

13. The pre-emphasis network of claim 12, wherein said switch has a plurality of positions, and wherein switch selections between said positions varies either the pre-emphasis time constant, gain across selected frequencies, and bass boost, such that when said pre-emphasis network is positioned in the signal path between an audio source and the modulator circuit of a transmitter, a transmitter operator may select the type of pre-emphasis most appropriate to the audio source for the transmitter and the system that finally demodulates and reproduces the audio signals being transmitted.

14. The pre-emphasis network of claim 13, wherein said switch has five positions, and wherein in a first position 1, switch S601 connects the junction of said third resistor R103 and said second capacitor C102 with a third capacitor C601 to create a pre-emphasis that provides approximately 4.5 dB of increased gain at frequencies above 5 KHz.

15. The pre-emphasis network of claim 14, wherein said third capacitor has a value of 2400 Pico-Farads.

16. The pre-emphasis network of claim 14, wherein in a second position, said switch connects the junction of said third resistor R103 and said second capacitor C102 with a capacitor C602 having a value to create a pre-emphasis of 75 microseconds and a relatively flat gain across frequencies between 0 KHz and 50 KHz.

17. The pre-emphasis network of claim 16, wherein said capacitor C602 has a value of 1000 Pico-Farads.

18. The circuit of claim 14, wherein in a third position, said switch is open and does not connect any additional components with the junction of said third resistor R103 and said second capacitor C102.

19. The pre-emphasis network of claim 18, wherein in the third position, the pre-emphasis network provides a pre-emphasis of 50 microseconds and approximately 3 dB of decreased gain at frequencies above 5 KHz.

20. The pre-emphasis network of claim 14, wherein in a fourth position, said switch connects the junction of said third resistor R103 and said second capacitor C102 with a resistor R601 so as to create a pre-emphasis providing approximately 6 dB of increased gain at frequencies below 5 KHz.

21. The pre-emphasis network of claim 20, wherein resistor R601 has a value of 18000 Ohms.

22. The pre-emphasis network of claim 14, wherein in a fifth position, switch connects the junction of said third resistor R103 and said second capacitor C102 with the parallel components of a capacitor C603 and a resistor R602, thereby creating a pre-emphasis that provides approximately 3 dB of increased gain at frequencies below 5 KHz and approximately 4.5 dB of increased gain at frequencies above 5 KHz.

23. The pre-emphasis network of claim 22, wherein said capacitor C603 has a value of 2400 Pico-Farads.

24. The pre-emphasis network of claim 22, wherein said resistor R602 has a value of 47000 Ohms.

25. The pre-emphasis network of claim 1, further including a set of components connected between circuit ground and the junction of said third resistor R103 and said second capacitor C102 that can be switched in and out of the pre-emphasis network by the actions of a logical switching device.

26. The pre-emphasis network of claim 25, wherein said logical switching device is selected from the group consisting of programmable logic device (PLD), microprocessor, and digital signal processor.
